(19) United States
(12) Patent Application Publication
(10) Pub. No.: US 2009/0108229 A1
(43) Pub. Date: Apr. 30, 2009

(54) MAGNETITE POWDER AND METHODS OF MAKING SAME

(75) Inventors: Brett Silverman, Philadelphia, PA (US); Bing Zhou, Cranbury, NJ (US)

Correspondence Address: Workman Nydegger;1000 Eagle Gate Tower, 60 East South Temple, Salt Lake City, UT, 84111, US

(73) Assignee: HEADWATERS TECHNOLOGY INNOVATION, LLC, Lawrenceville, NJ (US)

(21) Appl. No.: 11/925,147

(22) Filed: Oct. 26, 2007

(51) Int. Cl. C01G 49/08

(52) U.S. Cl. 252/62.56; 423/632; 428/403

(57) ABSTRACT

Magnetite powders are manufactured by first forming a precursor mixture containing iron atoms bonded to organic control agent molecules. Thereafter, magnetite is formed by (i) causing or allowing the iron atoms in the precursor mixture to form iron particles and (ii) reducing the iron atoms using a reducing agent. The magnetite powders obtained using the methods of the invention are superparamagnetic and can have very low densities. In one embodiment, the magnetite powders include a carbon coating on the magnetite particles which makes the particles resistant to being oxidized.

### BACKGROUND OF THE INVENTION

1. The Field of the Invention

The present invention relates generally to the manufacture of magnetite powder. More particularly, the present invention relates to methods for manufacturing low density and superparamagnetic magnetite powders using an organic control agent.

2. The Related Technology

Magnetite has a chemical formula of Fe₃O₄ and is one of three common oxides of iron, which are FeO, Fe₂O₃ and Fe₃O₄. Magnetite particles have recently been used in many important technological applications. Dispersions of iron have been used commercially in applications such as rotary shaft sealing for vacuum vessels, oscillation damping for various electronic instruments, and position sensing for avionics, robotics, machine tool, and automotive. Magnetite particle dispersions have been used in printing applications such as high quality toners or inks. Magnetite dispersion is also useful for the manufacture of liquid crystal devices, including color displays, monochromatic light switches, and tunable wavelength filters. As a semiconducting ferrimagnet with high Curie temperature (858 K), magnetite has shown great potential in tunneling device fabrication. The use of magnetite particles in clinical medicine is an important field in diagnostic medicine and drug delivery. Magnetite particles can interfere with an external homogeneous magnetic field and can be positioned magnetically in a living body, facilitating magnetic resonance imaging (MRI) for medical diagnosis, and AC magnetic field induced excitation for cancer therapy. Magnetite has also been used in various environmental applications such as the degradation of chlorinated hydrocarbons and hard metals in contaminated waters and soils.

Various methodologies have been utilized to synthesize magnetite nanoparticles. One common method uses the co-precipitation of mixed ferrous (Fe⁺²) and ferric (Fe⁺³) ions under basic conditions. Another method uses the thermal decomposition of an alkaline solution of an Fe⁺³ chelate in the presence of hydrazine, and the sonochemical decomposition of an Fe⁺² salt followed by thermal treatment. Yet another method includes grinding magnetite in a ball mill for an extended period of time in the presence of a surfactant and solvent. Uniformly sized magnetite particles have also been synthesized by the high-temperature reaction of iron (III) acetylacetonate in a high boiling organic solvent, which is both highly expensive and technically impractical on a commercial scale.

### BRIEF SUMMARY OF THE INVENTION

The present invention relates to a novel magnetite powder and improved methods for manufacturing magnetite powders. The magnetite powders are manufactured by first forming a precursor mixture containing iron atoms bonded to organic control agent molecules. Thereafter, magnetite is formed by (i) causing or allowing the iron atoms in the precursor mixture to form iron particles and (ii) reducing the iron atoms in the particles using a reducing agent. The magnetite powders obtained using the methods of the invention are superparamagnetic and can have very low densities. The excellent paramagnetic properties and/or low density of the magnetite materials of the invention are advantageous for blending the magnetite powders with other materials to make a composite.

The methods for making the magnetite powder include forming an iron precursor mixture. The precursor mixture includes a solvent, a plurality of iron atoms, and an organic control agent. The organic control agent includes organic molecules that have one or more functional groups (e.g., a carboxylic acid group) capable of bonding with the iron atoms. The organic control agent molecules can be selected to provide a desired and controlled formation of iron particles. In the precursor mixture, the separation of the iron atoms and the interaction of the iron atoms is controlled by the size of the control agent molecules and types of functional groups on the control agent molecules. Examples of suitable organic control agents include small organic molecules and polymers that have functional groups such as, but not limited to, a hydroxyl, a carboxyl, a carbonyl, an amine, an amide, a nitrile, a nitrogen with a free lone pair of electrons, an amino acid, a thiol, a sulfonic acid, a sulfonyl halide, or an acyl halide.

The solvent used to form the precursor mixture is selected to facilitate the formation of small iron particles. In one embodiment, the invention can be carried out using an aqueous solvent. The use of the above mentioned control agents in combination with a water-based solvent can be advantageous for forming very small particles of a desired configuration. Using water, either alone or in combination with other relatively low boiling point solvents in the presence of the above mentioned control agents allows for particle formation at relatively low temperatures. In one embodiment, particle formation is carried out at a temperature less than 200° C., more preferably less than about 150° C., and most preferably less than about 100° C.

The precursor mixture can include various acids, alcohols, and/or stabilizing agents to influence the interaction between iron atoms and also the interaction between iron atoms and the solvent. Acids can be added to facilitate bonding between the control agent molecules and the iron atoms, particularly where the iron atoms are provided as iron metal (i.e., ground state iron). Examples of optional acids include mineral acids such as, but not limited to, HCl.

One or more stabilizers can be included in the precursor mixture to facilitate formation of particles of a desired size. Examples of suitable stabilizers that can be included in the precursor mixture include, but are not limited to, ethylene glycol, polyethylene glycol (350-4000 Da), aminopropyltriethoxy silane (APTES), and/or polyoxyethylene octyl phenyl ether (e.g., Triton-X 100).

In contrast to the present invention, many of the techniques known in the art for making magnetite powder are difficult to employ in large-scale production because they require expensive, and often toxic, reagents, complicated synthesis steps, and/or high reaction temperatures. The magnetite powders of the present invention can be economically manufactured on a large scale (e.g., 1-100 kg) under relatively safe conditions. Moreover, the magnetite powders manufactured according to embodiments of the invention exhibit high percentages of the magnetite phase (e.g., 95-99% by weight magnetite) and low density (e.g., less than 1.0 g/ml bulk density or less than 5.1 g/ml true density), which gives the magnetite powders unique properties that can be beneficially employed in many applied uses of the magnetite powders.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a high resolution TEM image of magnetite powder manufactured according to one embodiment of the present invention;

FIG. 1B is a close up of a particle of the magnetite powder of FIG. 1A;

FIG. 2 is a TEM image of iron nanoparticles manufactured according to the invention showing aggloemrates;

FIG. 3 is a high resolution TEM image of commercially available magnetite powder;

FIG. 4 is a high resolution TEM image of another commercially available magnetite powder; and

FIG. 5 is a high resolution TEM image showing a close-up of a portion of the powder of FIG. 1A and revealing a carbon coating on the magnetite particle.

### DETAILED DESCRIPTION OF EXAMPLE EMBODIMENTS

### I. Introduction and Definitions

The present invention is directed to methods for making magnetite powders and novel magnetite powders that exhibit beneficial characteristics.

### II. Components Used to Manufacture Magnetite Powders

The following components can be used to carry out the above mentioned steps for manufacturing magnetite powder according to one embodiment of the present invention.

A. Iron Compounds

The iron atoms are provided as an iron compound such as an iron metal or iron salt. Examples of suitable iron compounds include iron chloride, iron sulfate, iron nitrate, iron oxide, or other iron salts. The iron compound may be water soluble (at pH=7), as in the case of an iron chloride and other iron salts, or it may be insoluble in a neutral aqueous medium, as in the case of iron metal and iron oxide. In one embodiment, iron metal is used in order to avoid incorporating compounds that include the anion of the iron salt.

Optionally, the iron compounds may be used in various combinations with other elements, such as other transition metals, including noble metals, rare earth metals, alkaline metals, alkaline earth metals, or even non-metals.

B. Organic Control Agent

An organic control agent is complexed with the iron atoms to control formation of the iron particles. The control agent is selected to promote the formation of nanoparticles that have a desired stability, size, and/or uniformity. Control agents within the scope of the invention include a variety of small organic molecules, polymers, and oligomers. The control agent can interact and bond with the iron atoms dissolved or dispersed within an appropriate solvent or carrier through various mechanisms, including ionic bonding, covalent bonding, lone pair electron bonding, or hydrogen bonding. In a preferred embodiment, the organic control agent is soluble in solvents comprising water and most preferably the organic control agent is water soluble.

To provide the bonding between the control agent and the iron atoms, the control agent includes one or more appropriate functional groups. Preferred control agents include functional groups which have either a charge or one or more lone pairs of electrons that can be used to complex an iron atom, or which can form other types of bonding. These functional groups allow the control agent to have a strong binding interaction with the iron atoms. In one embodiment, the functional groups of the control agent comprise one or more members selected from the group of a hydroxyl, a carboxyl, a carbonyl, an amine, an amide, a nitrile, a nitrogen with a free lone pair of electrons, an amino acid, a thiol, imidazole, phosphonic acid, phosphinic acid, a sulfonic acid, a sulfonyl halide, or an acyl halide. In one embodiment, short chain alcohols (e.g., ethanol and methanol) can be avoided to prevent flocculation of the magnetite particles.

The control agent can be monofunctional, bifunctional, or polyfunctional. Examples of suitable monofunctional control agents include carboxylic acids such as formic acid and acetic acid. Useful bifunctional control agents include diacids such as oxalic acid, malic acid, malonic acid, maleic acid, succinic acid, and the like; hydroxy acids such as glycolic acid, lactic acid, and the like. Useful polyfunctional control agents include polyfunctional carboxylic acids such as citric acid, pectins, cellulose, and the like. Other useful control agents include ethanolamine, mercaptoethanol, 2-mercaptoacetate, amino acids, such as glycine, and sulfonic acids, such as sulfobenzyl alcohol, sulfobenzoic acid, sulfobenzyl thiol, and sulfobenzyl amine. The control agent may even include an inorganic component (e.g., silicon-based).

Suitable polymers and oligomers within the scope of the invention include, but are not limited to, polyacrylates, polyvinylbenzoates, polyvinyl sulfate, polyvinyl sulfonates including sulfonated styrene, polybisphenol carbonates, polybenzimidizoles, polypyridine, sulfonated polyethylene terephthalate. Other suitable polymers include polyvinyl alcohol, polyethylene glycol, polypropylene glycol, and the like.

C. Solvents

The solvent serves as a carrier for the control agent molecules and the iron atoms. Various solvents or mixtures of solvents can be used, including water and organic solvents. Solvents participate in particle formation by providing a liquid medium for the interaction of iron atoms and control agent. In some cases, the solvent may act as a secondary control agent in combination with a primary control agent that is not acting as a solvent. In one embodiment, the solvent also allows the nanoparticles to form a suspension. Suitable solvents include water, methanol, ethanol, n-propanol, isopropyl alcohol, acetonitrile, acetone, tetrahydrofuran, ethylene glycol, dimethylformamide, dimethylsulfoxide, methylene chloride, and the like, including mixtures thereof. In a preferred embodiment, the precursor mixture includes water and more preferably water as the primary solvent component.

The solvent can also include additives to assist in the formation of the nanoparticles. For example, mineral acids and basic compounds can be added. Examples of mineral acids that can be used include hydrochloric acid, nitric acid, sulfuric acid, phosphoric acid, and the like. Examples of basic compounds include sodium hydroxide, potassium hydroxide, calcium hydroxide, ammonium hydroxide, tetrapropyl ammonium hydroxide, and similar compounds. As discussed below, in one embodiment, a base can be added in sufficient concentrations to cause the magnetite particles to precipitate from the precursor mixture.

D. Reducing Agents

A reducing agent is used to reduce at least some of the iron atoms from iron (III) to iron (II) to form magnetite (Fe₃O₄). Any reducing agent can be used that has sufficient reductive potential to carry out the redox reaction to make magnetite. The reducing agent can be applied as a gas, a liquid, or a solution. Examples of suitable reducing agents include, H₂, NaBH₄, and hydrazine, sulfites, and organic acids (e.g., oxalic acid).

E. Stabilizers

A stabilizer compound can be included in the precursor mixture to control dispersion of the complexed iron atoms and/or influence the primary particle size of the magnetite particles. The stabilizer compounds can interact with the control agent and influence the dispersion of the control agent in the solvent and/or affect the interaction between control agent molecules. Examples of suitable stabilizers include ethylene glycol, polyethylene glycol (350-4000 Da), aminopropyltriethoxy silane (APTES), and polyoxyethylene octyl phenyl ether (e.g., Triton-X 100), sulfonic acids, phosphonic acids, ethylene glycol ethers, imidazoles, thiols, amines, salts of long chained organic acids, such as, but not limited to, sodium oleate, potassium oleate, sodium linoleic acid, sodium dodecyl benzene, sodium docusate, poly acrylic acid-sodium salt, among others.

### III. Manufacturing Magnetite Powders

The magnetite powders are manufactured by first forming a precursor mixture containing iron atoms bonded to organic agent molecules. Thereafter, magnetite is formed by (i) causing or allowing the iron atoms in the precursor mixture to form iron particles and (ii) reducing the iron atoms using a reducing agent.

A. Forming a Precursor Mixture

The precursor mixture is formed by selecting one or more appropriate solvents, one or more organic control agents, one or more iron compounds, and optionally one or more stabilizers. The iron compound is selected to be soluble in the solvent or can be made soluble by including an additive in the solvent. In one embodiment, the solvent is an aqueous solvent and the iron compound is an iron salt (e.g., iron chloride). Alternatively the iron compound can be iron metal in the ground state. Iron metal can be dissolved in the solvent by adding an acid (e.g., HCl). The iron can be included in the precursor mixture in an amount of about 1 wt % to about 20 wt %.

The organic control agent is selected in combination with the iron compound and the solvent to be soluble in the precursor mixture. In a preferred embodiment, the solvent includes water and the organic control agent is water soluble. The organic control agent and the iron compound are also selected such that the functional groups on the organic control agent will react with the iron atoms while in the solvent. The organic control agent is typically included in the precursor mixture in a concentration range of about 10 wt % to 30 wt %, more preferably from about 15 wt % to about 25 wt %.

It can also be advantageous to control the molar ratio of organic control agent molecules to the iron atoms. An even more useful measurement is the molar ratio between control agent functional groups and the iron atoms. In one embodiment, the molar ratio of control agent functional groups to iron atoms is preferably in a range of about 3:1 to about 10:1, more preferably in a range of about 4:1 to about 6:1.

Upon mixing the iron atoms and the organic control agent molecules together in the solvent, the iron atoms react with the functional groups on the organic control agent to form the precursor mixture. The iron atoms in the precursor mixture are typically in a 3+ oxidation state or higher, although the invention can be carried out with some or all of the iron in a different oxidation state.

In a preferred embodiment, the precursor mixture comprises an aqueous based solvent mixture. Examples of suitable iron compounds that can be used in an aqueous solvent include iron salts such as iron chloride and iron nitrates. Examples of suitable organic control agents that can be used in combination with an aqueous solvent and the foregoing iron compounds include, but are not limited to, glycolic acid, citric acid, acrylic acid, adipic acid, polyacrylic acid.

Optionally a stabilizing agent can be added to the precursor mixture to control the dispersion and/or stability of the iron-organic agent complexes. The stabilizing agent typically is selected to interact with the organic control agent molecules. In one embodiment, the stabilizing agent can be selected to be soluble in a water based solvent. Examples of suitable stabilizing agents for use in an aqueous precursor mixture include ethylene glycol, polyethylene glycol (350-4000 Da), aminopropyltriethoxy silane (APTES), polyoxyethylene octyl phenyl ether (e.g., Triton-X 100), α,ω-phosphonic acids, and α,ω-sulfonic acids. The stabilizer can be included in the precursor mixture in a concentration in a range from about 1 wt % to about 20 wt %.

In one embodiment, the precursor mixture can be manufactured at room temperature and atmospheric pressures. Those skilled in the art will recognize that other temperatures and pressures can be used if desired. In a preferred embodiment, the precursor mixture is relatively stable at room temperature and pressure (e.g., stable for one or more hours).

B. Forming Magnetite Powder

Once the precursor mixture has been formed, the precursor mixture is used to form a magnetite powder. The magnetite powder is formed by (i) allowing or causing the iron atoms in the precursor mixture to form nanoparticles and (ii) reducing a portion of the iron atoms to iron (II).

1. Particle Formation

Nanoparticles can be formed in any way that yields a particle of a desired size. For example, the nanoparticles can be formed by evaporating off at least a portion of the solvent or by precipitating the nanoparticles from the precursor mixture. In a preferred embodiment, particle formation is carried out at a relatively low temperature. In one embodiment, particle formation is carried out at a temperature less than about 200° C., more preferably less than about 150° C., even more preferably less than about 100° C., and most preferably less than about 90° C. Forming the nanoparticles at a low temperature can be advantageous for achieving a small primary particle size.

In one embodiment, particle formation is carried out by evaporating off the solvent. Preferably the solvent is selected to be a low boiling solvent to achieve particle formation within the above preferred temperatures ranges. For example, the solvent is preferably water and/or low boiling alcohols, or other low boiling organic solvents and mixtures of these.

In an alternative embodiment, iron nanoparticles can be formed by causing the iron to precipitate from the precursor mixture. In one embodiment, the iron is caused to precipitate by adding a base to the precursor solution. The concentration of base needed to cause precipitation will depend on the control agent, solvent, and other additives in the precursor mixture. Examples of suitable bases that can be used to cause precipitation include sodium hydroxide, potassium hydroxide, calcium hydroxide, ammonium hydroxide, tetrapropyl ammonium hydroxide, and similar compounds. Once the iron particles have been precipitated, the particles can be collected using filtration or other suitable technique and dried to yield a powder.

2. Iron Reduction

In addition to forming nanoparticles, a portion of the iron atoms are reduced to achieve magnetite (iron (II) (III) oxide). The reduction step can be carried out before, after, or simultaneously with nanoparticle formation.

The duration of the reduction step and/or the type of reducing agent are selected to ensure the formation of magnetite. The reduction step is carried out using a reducing agent for a sufficient amount of time to ensure that at least a portion of the iron atoms are converted to iron (II) to yield magnetite, not iron (III) oxide (i.e., Fe₂O₃). However, the severity and/or duration of the reduction is limited to ensure that at least some of the iron atoms remain as iron (III) so as to achieve magnetite and not just iron (II) oxide (i.e., FeO). In one embodiment, reduction is carried out so as to achieve at least about 50% by weight magnetite in the iron powder, preferably at least about 75% by weight magnetite, more preferably at least about 90% by weight magnetite, even more preferably at least about 95% by weight magnetite, and most preferably greater than about 99% by weight magnetite.

Reduction can be carried out in the gas phase using a gaseous reducing agent such as hydrogen. Alternatively, reduction can be carried out in the liquid phase using a reducing agent dissolved in the precursor mixture. Examples of suitable reducing agents include H₂, NaBH₄, and hydrazine.

In one embodiment, the reduction step is carried out on an intermediate solid material following particle formation and removal of the solvent. In this embodiment, the intermediate solid material is reduced to form a magnetite powder by heating the intermediate solid material in the presence of the reducing agent. The intermediate solid material can be heated in a reducing environment at a temperature in a range from about 300° C. to about 450° C. for a duration of about 0.5 hour to about 24 hours, more preferably at a temperature in a range from about 350° C. to about 400° C. for a duration of about 1.0 hour to about 12 hours. The magnetite powders manufactured using this method yield primary particle sizes in a range from about 2 nm to about 50 nm, more preferably in a range from about 5 nm to about 20 nm.

In an alternative embodiment, the iron atoms are reduced while still in the precursor mixture. In this embodiment, the reducing agent is mixed into the precursor solution and thereafter or simultaneous with the reduction are caused to form magnetite nanoparticles. Examples of suitable reducing agents that can be added to the precursor mixture include organic reducing agents, NaBH₄, hydrazine, and/or reducing gases (e.g., hydrogen that is bubbled through the solution). The iron can be precipitated from solution using any technique that yields particles of a desired size.

### IV. Magnetite Powders

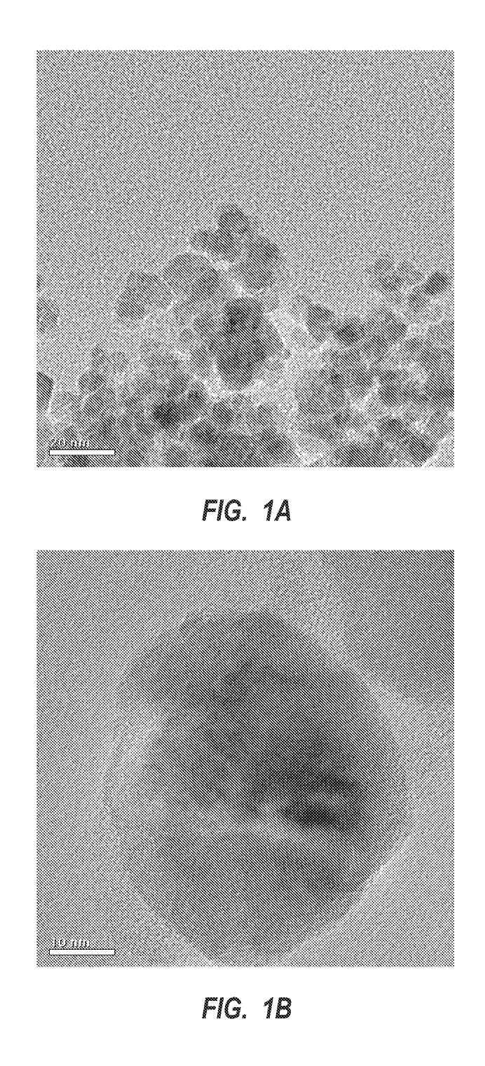

The magnetite powders manufactured according to the present invention have very small primary particle sizes and exhibit super paramagnetic properties. In one embodiment, the primary particle size is in a range from about 1-100 nm, more preferably about 2-50 nm, and most preferably in a range from about 5-20 nm. FIGS. 1A and 1B are TEM images showing the primary particle size of magnetite powders according to one embodiment of the invention.

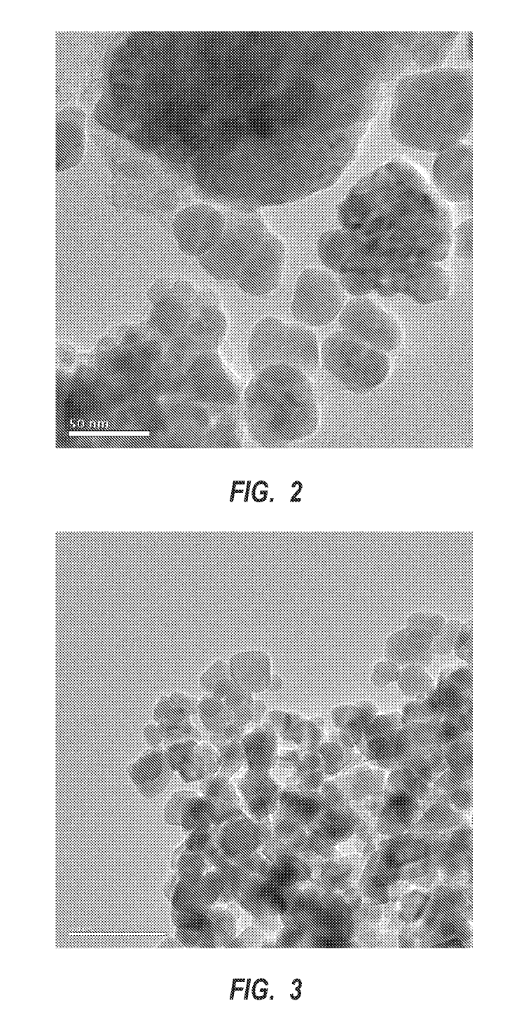

In some embodiments, the primary particles are agglomerated such that they form a larger secondary structure. In one embodiment, the particle size of the secondary structure is in a range from about 500 nm to about 10 microns, alternatively in a range from about 1 micron to about 5 microns. Despite the larger secondary structure, the magnetite powders exhibit paramagnetic properties that are indicative of the nano-sized primary particles. FIG. 2 is a TEM image of iron nanoparticles manufactured according to the invention showing aggloemrates.

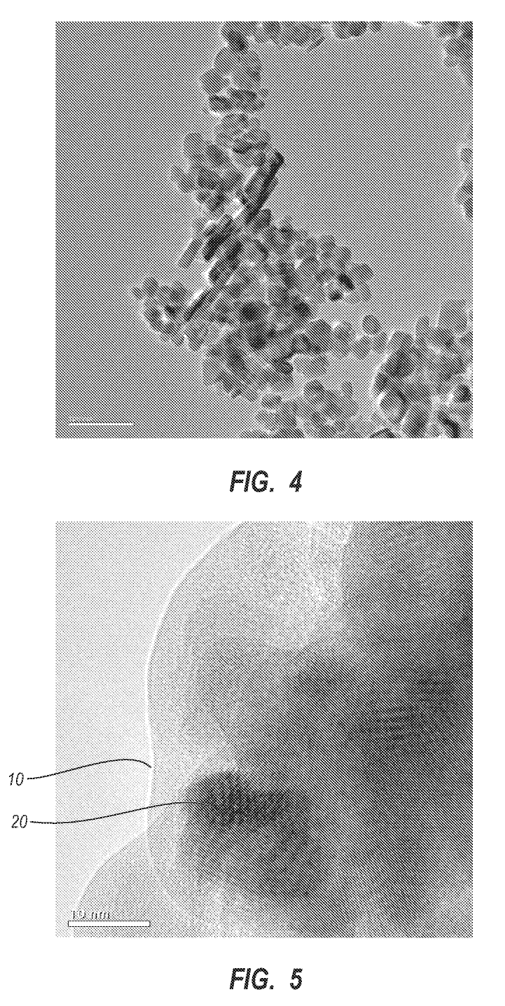

FIGS. 3 and 4 show TEM images of magnetite powders that are commercially available. FIG. 3 is a TEM image of nanopowder available from Sigma-Aldrich (cat #637106). FIG. 4 is a TEM image of an iron oxide nanopowder available from Alfa-aesar (Item #4466). The commercially available nanopowders have substantially larger particle sizes compared to the nanopowders manufactured according to the present invention.

Surprisingly, the magnetite powders manufactured according to the invention can have very low densities. In one embodiment, the “true density” of the iron powders is in a range from about 4.6 g/cm³ to about 5.1 g/cm³ more preferably in a range from about 4.7 g/cm³ to about 5.0 g/cm³, as measured using a gas pycnometer. For purposes of this patent application “true density” is the density measured using a gas pycnometer. Alternatively the density can be measured according to “bulk density.” In one embodiment, the bulk density of the powders of the invention can be in a range from about 0.7 g/ml to about 1.2 g/ml, more preferably in a range from about 0.8 g/ml to about 1.05 g/ml. The low density of the magnetite powders reduces the weight of the material while still achieving the same level of magnetic force. This property is advantageous when incorporating the material into other materials that can be affected by the weight and bulk of the magnetite powder.

In one embodiment, the magnetite nanopowders manufactured according to the invention include a carbon coating on the magnetite particle. FIG. 5 is a close up of a particle of a nanopowder manufactured using the methods described above. As can be seen in the TEM, the powder includes a coating on the magnetite particles. The coating has been determined to be a carbon coating. In one embodiment, the carbon coating is created during the heating/reduction step from the organic control agent.

The carbon coating in the magnetite nanopowders of the invention is particularly advantageous for imparting oxidative stability to the magnetite particles. The magnetite particles of the invention have been found to be stable in water over a wide pH range for months. This is in contrast to nanopowders that do not have a carbon coating, which can oxidize from Fe₃O₄ to Fe₂O₃ in oxidative conditions.

The magnetite powders of the invention are advantageously incorporated into a bulk material to form a composite. Suitable bulk materials include organic and inorganic polymers, such as but not limited to PMMA, PMA, polyethylene, polypropylene, polyvinyl chloride, polyethylene terephthalate, polystyrene and polycarbonate.

### V. Examples

The following examples provide formulas for making magnetite powders according to the present invention.

### Example 1

### Evaporation Method

Example 1 describes a method for making a magnetite powder using an evaporation technique. An iron precursor solution was prepared by mixing 500 g of Fe metal (Spectrum), 1548 g citric acid (Aldrich), and 6590 g deionized H₂O inside a high shear mixing vessel at room temperature and pressure. The high and low shear blades were started at 4500 and 1500 rpm respectively followed by the addition of 953 g glycolic acid. The reaction proceeded under high shear mixing for 4-12 hrs, and the temperature rose to 140° F.-180° F. The mixture turned from a milky greenish white to a dark brown color and the reaction complete. This brown iron solution was then dehydrated using a simple distillation setup (150° C., 10-100 morr). Once the water had been removed, the dried residue was heated in the presence of hydrogen (5% hydrogen in nitrogen) for 6 hrs. The resulting material was jet black in color, and was confirmed by XRD as magnetite.

### Example 2

### Precipitation Method

Example 2 describes a method for making a magnetite powder using precipitation. An iron precursor solution was made using the steps set forth in Example 1. To this solution, an excess of sodium hydroxide was added until a brown precipitate formed. This precipitate was then isolated via filtration and reduced in solution through addition of 500 ml of hydrazine (sigma Aldrich, 30% in water) (reduction can also be carried out using H₂ gas/heat in the same manner as described in Example 1). This solution was stirred for 4 hours and the now black solid was isolated via magnetic separation and decantation. The material was washed repeatedly with distilled water, and finally dried. This material was characterized by XRD as magnetite.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A low density magnetite powder, comprising:
a powder comprised of a plurality of particles having a size less than about 10 microns, the particles comprising magnetite (Fe₃O₄) and a carbon coating.

2. A magnetite powder as in claim 1, wherein the true density of the particles is in a range from about 4.6 g/cm³ to about 5.1 g/cm³.

3. A magnetite powder as in claim 1, wherein the true density of the particles is in a range from about 4.7 g/cm³ and about 5.0 g/cm³.

4. A magnetite powder as in claim 1, wherein the particles have a primary particle size in a range from about 1 nm to about 100 nm.

5. A magnetite powder as in claim 1, wherein the particle comprises at least about 90% by weight magnetite.

6. A composite material comprising the magnetite powder of claim 1 mixed into a bulk material.

7. A method for manufacturing a magnetite powder, comprising:
forming a precursor mixture comprised of,
a solvent;
a plurality of iron atoms; and
an organic control agent comprised of a plurality of organic molecules having at least one functional group complexed with at least one of the iron atoms;
forming a plurality of magnetite particles by causing or allowing the iron atoms in the precursor mixture to form iron particles and reducing the iron atoms to form magnetite.

8. A method as in claim 9, wherein the solvent comprises water.

9. A method as in claim 9, wherein the organic control agent comprises organic molecules having at least one functional group per 16 carbon atoms.

10. A method as in claim 9, wherein the organic control agent is selected from the group consisting of glycolic acid, citric acid, acrylic acid, adipic acid, polyacrylic acid.

11. A method as in claim 9, wherein the iron particles are formed at a temperature less than 200° C.

12. A magnetite powder manufactured according to the method of claim 11.

13. A method for manufacturing a magnetite powder, comprising:
forming a precursor mixture comprised of,
a solvent;
a plurality of iron atoms; and
an organic control agent comprised of a plurality of organic molecules having at least one functional group complexed with at least one of the iron atoms;
forming an intermediate solid material by evaporating at least a portion of the solvent from the precursor mixture and recovering the intermediate solid material; and
heating the intermediate solid material in the presence of a reducing agent to yield a magnetite powder.

14. A method as in claim 13, wherein the solvent comprises water.

15. A method as in claim 13, wherein the intermediate solid is formed at a temperature less than 200° C.

16. A method as in claim 13, wherein the intermediate solid is formed at a temperature less than about 150° C.

17. A method as in claim 13, wherein the intermediate solid material is heated in the presence of the reducing agent for about 0.5 to about 24 hours at a temperature in a range from about 300° C. to about 500° C.

18. A method as in claim 13, wherein the intermediate solid material is heated in the reducing environment for about 1 to about 12 hours at a temperature in a range from about 350° C. to about 450° C.

19. A method as in claim 13, wherein the reducing agent comprises hydrogen gas.

20. A method as in claim 13, wherein the organic control agent is selected from the group consisting of glycolic acid, citric acid, acrylic acid, adipic acid, polyacrylic acid.

21. A method as in claim 13, wherein the precursor mixture further comprises a stabilizing agent selected from the group consisting of ethylene glycol, polyethylene glycol (350-4000 Da), aminopropyltriethoxy silane (APTES), and polyoxyethylene octyl phenyl ether.

22. A low density magnetite powder manufactured according to the method of claim 13.

23. A method for manufacturing a magnetite powder, comprising:
forming a precursor mixture comprised of,
a solvent;
a plurality of iron atoms; and
an organic control agent comprised of a plurality of molecules that each have at least one functional group capable of bonding with the iron atoms;
adding a reducing agent to the precursor mixture to form a non-oxidizing intermediate solution; and
causing or allowing magnetite particles to precipitate from the intermediate solution and recovering the precipitated magnetite particles.

24. A method as in claim 23, wherein the solvent comprises water.

25. A method as in claim 23, wherein the intermediate solid is formed at a temperature less than 200° C.

26. A method as in claim 23, wherein the intermediate solid is formed at a temperature less than about 150° C.

27. A method as in claim 23, wherein the organic control agent is selected from the group consisting of glycolic acid, citric acid, acrylic acid, adipic acid, polyacrylic acid.

28. A method as in claim 23, wherein the particles are caused to precipitate by adding a base to the intermediate solution.

29. A method as in claim 28, wherein the base is selected from the group consisting of NaOH, KOH, NH₄OH, (Prop)₄NOH, and combinations thereof.

30. A method as in claim 23, wherein the precursor mixture further comprises a stabilizing agent selected from the group consisting of ethylene glycol, polyethylene glycol (350-4000 Da), aminopropyltriethoxy silane (APTES), and polyoxyethylene octyl phenyl ether.

31. A low density magnetite powder manufactured according to the method of claim 23.
